(19) United States
(12) Patent Application Publication
(10) Pub. No.: US 2015/0378537 A1
(43) Pub. Date: Dec. 31, 2015

(54) CUSTOMIZING DEVICE BASED ON COLOR SCHEMES

(71) Applicants: Verizon Patent and Licensing Inc., Arlington, VA (US); Cellco Partnership d/b/a Verizon Wireless, Arlington, VA (US)

(72) Inventors: Ramesh MARIMUTHU, Edison, NJ (US); Tanya CHERIFI, Basking Ridge, NJ (US)

(21) Appl. No.: 14/319,581

(22) Filed: Jun. 30, 2014

(51) Int. Cl. G06F 3/0484

(52) U.S. Cl. CPC G06F 3/0484

(57) ABSTRACT

A device may obtain information associated with a user, such as information regarding a user item of the user. The device may identify a particular color scheme based on the information regarding the user item. The device may apply the particular color scheme to a user interface of the device. For example, the device may apply a color of the particular color scheme to the user interface.

### BACKGROUND

A device may provide different types of information for display. The different types of information may include information relating to various applications of the device. The device may provide the different types of information using a wide range of colors.

### BRIEF DESCRIPTION OF DRAWINGS

FIGS. 1A-1C are diagrams of an overview of an implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for configuring a user device;

FIGS. 5A-5B are diagrams of an example of the process described in FIG. 4;

FIG. 6 is a flow chart of an example process for customizing color schemes of the user device; and

FIGS. 7A-7C, 8A-8C, 9A, and 9B are diagrams of examples of the process described in FIG. 6.

### DETAILED DESCRIPTION OF PREFERRED EMBODIMENTS

The following detailed description refers to the accompanying drawings. The same reference numbers in different drawings may identify the same or similar elements.

Various settings of a device may be customized. However, the user may only be provided with limited options for customizing colors and other visual information of different user interfaces of the device (e.g., a home screen user interface, a desktop screen user interface, a lock screen user interface, etc.), applications of the device, or the like. Additionally, customizing the colors and the other visual information may be difficult and may be tedious based on multiple actions required by the user. Accordingly, the experience of the user may be negatively affected and the user may be dissatisfied.

Systems and/or methods described herein may facilitate the customization of and enable the automatic customization of the color scheme of a device (e.g., color schemes of the different user interfaces of the device, the applications of the device, or the like).

The customization of the color scheme may be performed based on various factors. The various factors may include a user item of the user (e.g., a color of the user item), an event associated with the user, a location associated with the device or information regarding the location, an emotion of the user, a medical condition of the user, a quantity of communications and/or calendar events associated with the user, news (e.g., local, national, international, etc.), additional information regarding the user (e.g., eye color, hair color, etc.) or the like.

As used herein, a color (e.g., of an item) may be used to refer to a color, a texture, and/or a pattern (e.g., of the item). As used herein, a color scheme may include one or more colors, one or more patterns of one or more colors (e.g., representing texture and/or pattern of a user item), one or more objects (e.g., within an image), other visual information associated with the one or more colors and the one or more patterns of the one or more colors, or the like.

As used herein, a user item may include an article of clothing (e.g., a dress, a shirt, pants, a blouse, shoes, a belt, etc.), jewelry (e.g., ear rings, bangles, a necklace, etc.), accessories (nail polish, a bag, a hat, etc.), a vehicle (e.g., a car, a motorcycle, etc.), other material possessions of the user, or the like.

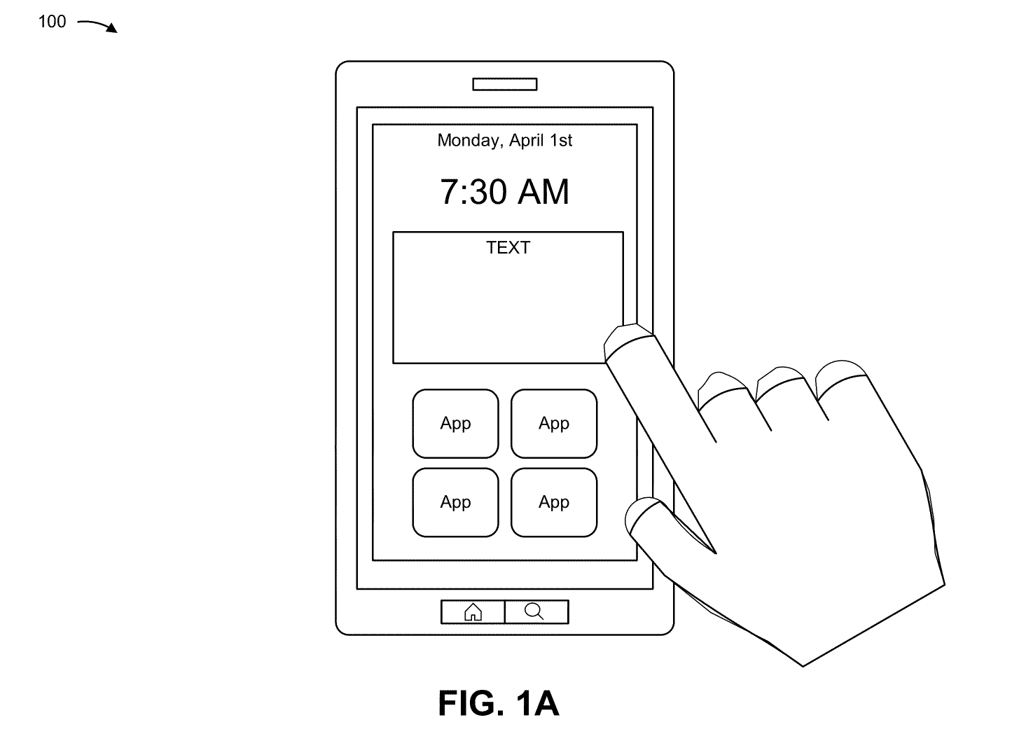

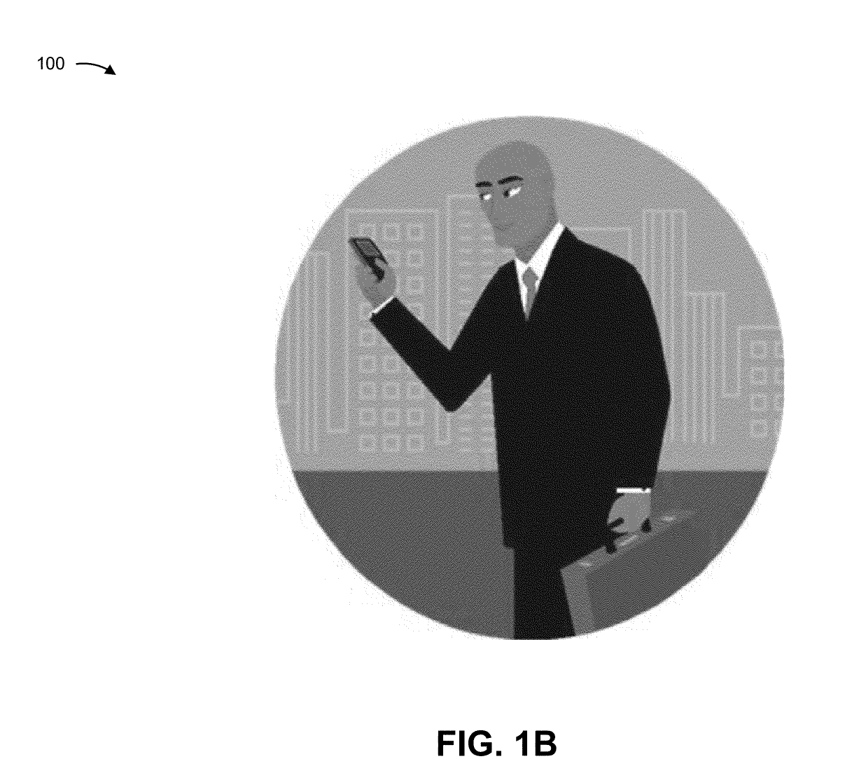

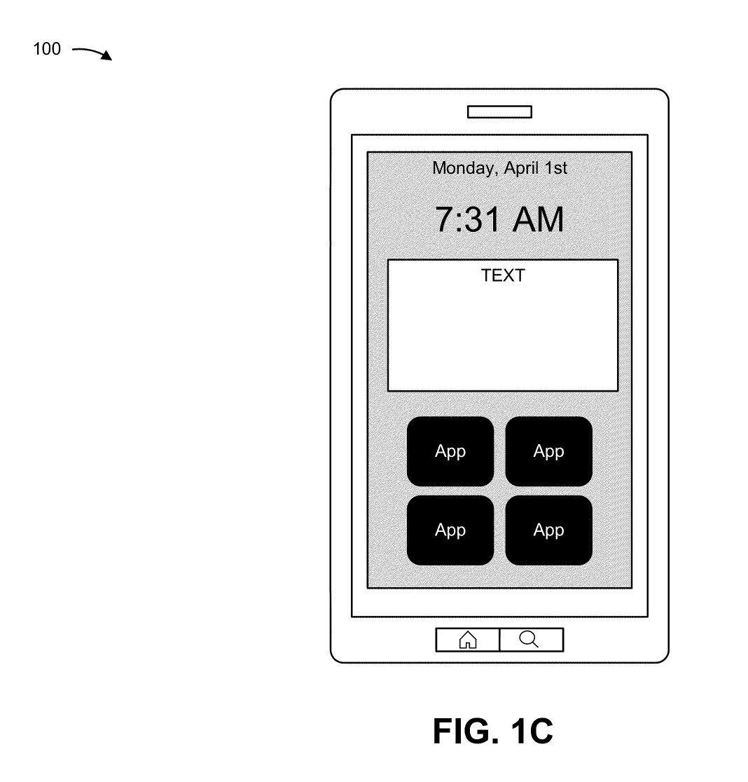

FIGS. 1A-1C are diagrams of an overview of an implementation described herein. As shown in FIG. 1A, assume, a user is using an application of a user device (e.g., a smart phone). Further, assume that a color customizing application has been initiated and is running as a background process on the user device.

As shown in FIG. 1B, assume that an event has occurred while the user is using the user device. The event may include, for example, a time to obtain information (e.g., based on a user request or independent of a user request) that may be used to identify a color scheme to be applied to the device. As further shown in FIG. 1B, assume the color customizing application has caused a camera of the user device to capture an image of one or more user items of the user. The color customizing application may analyze the image to identify colors of the one or more user items.

As shown in FIG. 1C, assume that the color customizing application has identified a color scheme corresponding to the colors of the one or more user items. As shown in FIG. 1C, the color customizing application may cause the identified color scheme to be applied to the user device.

Thus, systems and/or methods described herein may facilitate the customization of color schemes of devices.

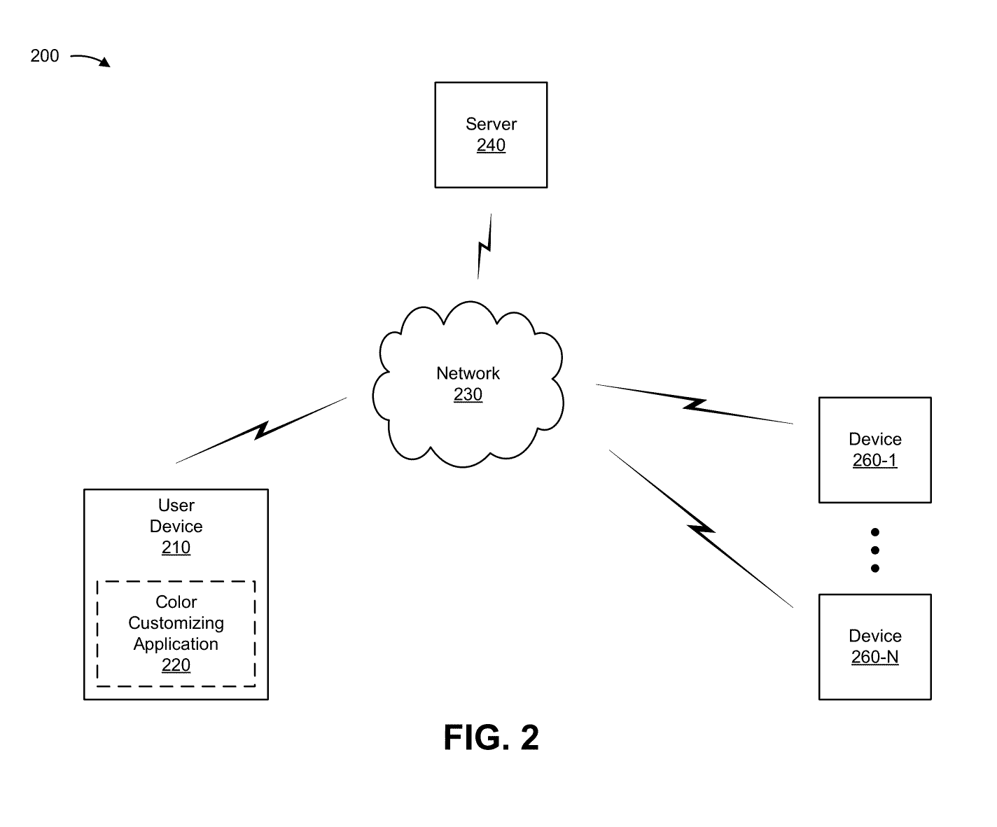

FIG. 2 is a diagram of an example environment 200 in which systems and/or methods described herein may be implemented. Environment 200 may include a user device 210, a network 230, a server 240, a network 250, and device 260-1 to device 260-N (N≧1) (referred to herein collectively as “devices 260” and referred to herein individually as “device 260”).

User device 210 may include one or more devices that are capable of customizing color schemes. For example, user device 210 may include a personal digital assistant (“PDA”) (e.g., that can include a radiotelephone, a pager, Internet/intranet access, etc.), a smart phone, a desktop computer, a laptop computer, a tablet computer, a gaming device, and/or another type of wired or wireless user device. In some implementations, user device 210 may include color customizing application 220. For example, user device 210 may download color customizing application 220 or may be preloaded with color customizing application 220. User device 210 may be configured, using color customizing application 220, to customize the color scheme of user device 210 and/or one or more devices 260.

Network 230 may include one or more wired and/or wireless networks. For example, network 230 may include a cellular network, a public land mobile network (“PLMN”), a second generation (“2G”) network, a third generation (“3G”) network, a fourth generation (“4G”) network, a fifth generation (“5G”) network, a long term evolution (“LTE”) network, and/or a similar type of network. Additionally, or alternatively, network 240 may include a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, a satellite network, a cloud computing network, and/or a combination of these or other types of networks.

Server 240 may include one or more server devices. In some implementations, server 240 may transmit color customizing application 220 to user device 210. Additionally, or alternatively, server 240 may obtain and store color schemes. Additionally, or alternatively, server 240 may transmit information regarding the color schemes to user device 210 and/or one or more of devices 260.

Device 260 may include one or more devices similar to user device 210 and/or a peripheral of user device 210 (e.g., a protective case of user device 210, a mouse, a keyboard, a headset, an earpiece, etc.). Color customizing application 220 may cause user device 210 to transmit information regarding the color scheme of user device 210 to a device 260. Accordingly, the color scheme of user device 210 may be applied to the device 260.

The number and arrangement of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

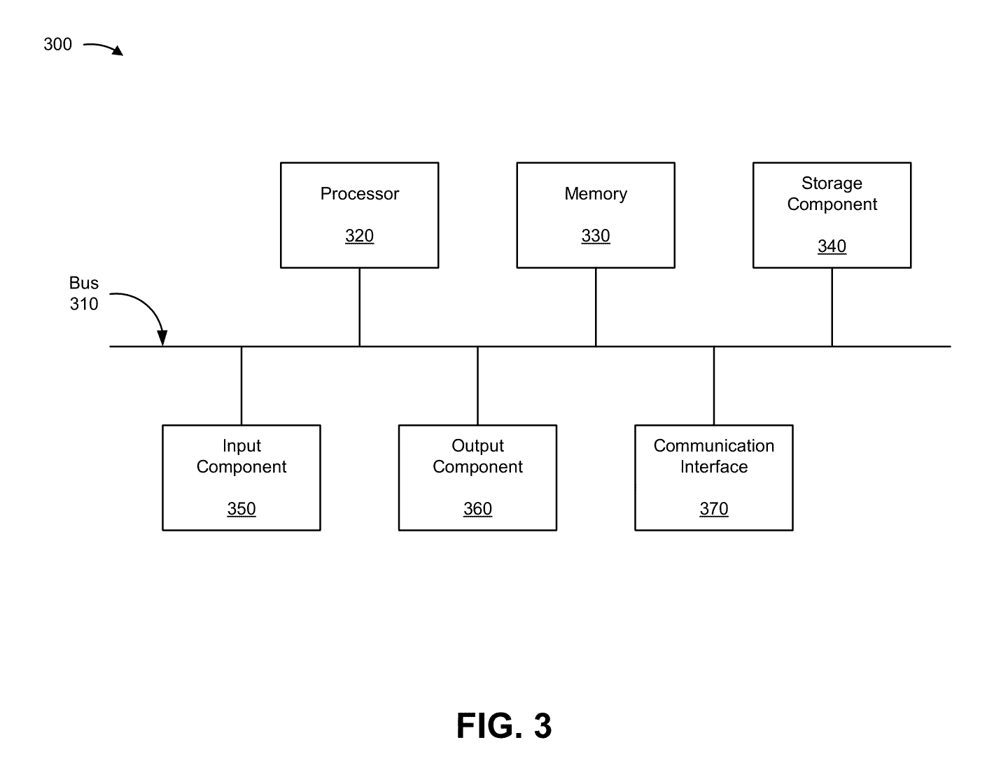

FIG. 3 is a diagram of example components of a device 300. Device 300 may correspond to user device 210, server 240, and/or device 260. Additionally, or alternatively, each of user device 210, server 240, and/or device 260 may include one or more devices 300 and/or one or more components of device 300. As illustrated in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing logic (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a camera, a microphone, a switch, etc.). Output component 350 may include a component that outputs information from device 300 (e.g., a display, an audio speaker, one or more light-emitting diodes (“LEDs”), etc.).

Communication interface 360 may include a transceiver-like component, such as a transceiver and/or a separate receiver and transmitter that enables device 300 to communicate with other devices, such as via a wired connection, a wireless connection, or a combination of wired and wireless connections. For example, a communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

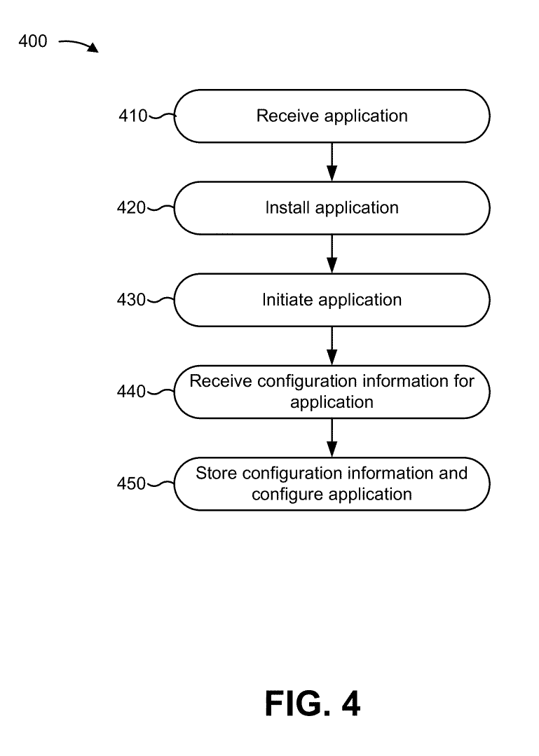

FIG. 4 is a flowchart of an example process 400 for configuring a user device to customize the color scheme of the user device. In some implementations, process 400 may be performed by user device 210. In some implementations, one or more process blocks of FIG. 4 may be performed by another device or a group of devices separate from or including user device 210, such as another device included in environment 200.

As shown in FIG. 4, process 400 may include receiving an application that may enable a user device to customize the color scheme of the user device (block 410). For example, user device 210 may receive color customizing application 220 along with information regarding different color schemes. In some implementations, a user of user device 210 may modify the different color schemes (as will be explained in more detail below). In some implementations, the different color schemes received with color customizing application 220 may include a respective color scheme for a respective location of different entities. Information regarding the respective color schemes may be transmitted (e.g., to server 240 and/or user device 210) by the different entities. In some implementations, a user of user device 210 may enable user device 210 to automatically receive updates to the respective color schemes and/or automatically receive additional color schemes (e.g., from the same entities and/or additional entities). Additionally, or alternatively, user device 210 may receive the updates to the respective color schemes and/or the additional color schemes based on input from the user.

In some implementations, user device 210 may be pre-loaded with color customizing application 220. In some implementations, user device 210 may receive color customizing application 220 from a memory. For example, user device 210 may receive color customizing application 220 from a flash drive, a Compact Disc-Read-Only Memory (CD-ROM), or any other type of memory. In some implementations, user device 210 may transmit a request to server 240 and may receive color customizing application 220 based on the request. For example, a user of user device 210 may cause user device 210 to access an application store or a website, which provides information regarding applications (including color customizing application 220) that may be obtained. The application store and/or the website may hosted by server 240. The user may then select, using user device 210, information regarding color customizing application 220 from the information regarding the applications to cause user device 210 to transmit a request for color customizing application 220. User device 210 may then receive color customizing application 220 based on the request.

As further shown in FIG. 4, process 400 may include installing the application (block 420). For example, after receiving color customizing application 220, user device 210 may store color customizing application 220 in a memory associated with user device 210 and install color customizing application 220.

As further shown in FIG. 4, process 400 may include initiating the application (block 430). For example, after receiving and installing color customizing application 220, user device 210 may receive a request (e.g., from a user of user device 210) to initiate color customizing application 220 and cause color customizing application 220 to be initiated. In some implementations, upon initiation, color customizing application 220 may provide, for display, information regarding particular color schemes. The particular color schemes may be provided as suggestions to the user. For example, the particular color schemes may include the different color schemes received with color customizing application 220. Additionally, or alternatively, the particular color schemes may include color schemes that are based on information regarding the user. For instance, the information regarding the user may identify a preference of the user with respect to a color, may identify information regarding locations that the user has visited, etc. In some instances, color customizing application 220 may identify the information regarding the user from data stored on user device 210 (as will be explained in more detail below). Additionally, or alternatively, the color schemes may include color schemes that are based on information regarding other users. For instance, the information regarding the users may identify color schemes that meet a threshold of usage by the users, colors schemes that are currently being used by the users, etc. In some implementations, user device 210 may transmit a request to server 240 and the information regarding the particular color schemes may be transmitted to user device 210 by server 240 based on the request. In some instances, the information regarding the particular color schemes may be generated by server 240 based on information regarding different color schemes used by one or more devices (such as devices 260) and transmitted by the one or more devices to server 240. In some implementations, color customizing application 220 may receive the information regarding the different color schemes (e.g., from server 240 and/or the one or more devices) and may generate the information regarding the particular color schemes based on the information regarding the different color schemes. For example, color customizing application 220 may poll a group of users to obtain feedback regarding a particular color scheme to be chosen for a particular period of time (e.g., a particular day, a particular week, a particular month, etc.), may identify a color scheme for which a threshold feedback was received, and may cause the identified color scheme to be applied to devices of the group of users and/or user device 210.

In some implementations, the information regarding the particular color schemes may be categorized. For example, the information regarding the particular color schemes may include information regarding a particular color scheme for a particular location or a particular type of location (e.g., a restaurant or an Italian restaurant), a particular color scheme for a particular emotion, a particular color scheme for a particular color (e.g., of a user item), information regarding a particular color scheme (e.g., a color scheme that meets a threshold of usage by users) at a current date and/or a current time, or the like.

As further shown in FIG. 4, process 400 may include receiving configuration information for configuring the application (block 440). For example, the user of user device 210 may submit the configuration information, via color customizing application 220, to configure color customizing application 220 after initiating color customizing application 220. In some implementations, the configuration information may be submitted by the user via user device 210. Additionally, or alternatively, the configuration information may be submitted by the user via a device 260 and transmitted to user device 210. Additionally, or alternatively, the configuration information may be submitted by the user via a web interface and transmitted to user device 210. In some implementations, the configuration information may include, for example, information identifying other devices and/or users, information identifying triggering events for initiating customization of the color scheme of the user device, information identifying different color schemes, or the like.

In some implementations, the user may submit the configuration information to configure color customizing application 220 using one or more elements of one or more user interfaces provided by user device 210. The one or more elements may include, for example, a text input element, a drop down menu elements, a checkbox elements, a radio button element, and/or any other type of elements that may be used to receive the information from the user. In some implementations, the configuration of color customizing application 220 may be performed automatically (i.e., without user intervention) by color customizing application 220 (e.g., based on a trigger event, such as a date and/or a time, a calendar event, information regarding a location of user device 210, etc.). In some implementations, the configuration of color customizing application 220 may be performed based on a request from the user.

In some implementations the configuration information may include information identifying devices and/or users. For example, the user of user device 210 may submit, via color customizing application 220, information identifying the other devices and/or other users to receive information regarding a color scheme applied to user device 210. In some implementations, the user of user device 210 may submit information identifying other devices of the user. In some implementations, the user of user device 210 may submit information identifying other users and/or devices of the other users. For example, the other users may include contacts of the user, members of a social network (or different social networks) of the user, any other group of users, etc. In some instances, information regarding a color scheme of user device 210 may be transmitted to another device and the color scheme of user device 210 may be applied to the other device. In some instances, color customizing application 220 may obtain information regarding the color scheme of the other device and may apply the color scheme to user device 210.

Additionally, or alternatively, the configuration information may include information identifying triggering events for the application. For example, the user of user device 210 may submit information identifying triggering events that may cause color customizing application 220 to obtain information used to identify a color scheme to be applied to user device 210. The information may include information identifying a color of a user item, information identifying an emotion of the user, information identifying a medical condition of the user and/or of another user (e.g., a family member of the user, a friend of the user, a member of a social network of the user, etc.), information identifying a quantity of communications and/or calendar events associated with the user, information regarding a location of the user, information regarding news (real time or non-real time), information regarding an event associated with the user, etc. As used herein, communications associated with the user may include e-mails received and/or transmitted by the user (e.g., via user device 210), telephone calls received and/or placed by the user, text messages received and/or transmitted by the user (e.g., via user device 210), social postings (e.g., social tweets) received and/or transmitted by the user (e.g., via user device 210), or the like. The quantity of communications and/or calendar events associated with the user may indicate whether the user is busy or available during a period of time associated with the communications and/or the calendar events. The event may include a calendar event, an event relating to sports, an event relating to art, an event relating to technology and/or science (e.g., a science fair), a political event, etc. In some implementations, the calendar event may identify the event relating to sports, the event relating to art, the event relating to technology and/or science, and the political event. Additionally, or alternatively, the user may submit information identifying an action to be taken by color customizing application 220 to obtain the information used to identify the color scheme to be applied to user device 210. In some implementations, the identified color scheme may be automatically applied to user device 210. In some implementations, the identified color scheme may be presented to the user and may be applied to user device 210 after input from the user. The input from the user may include an authorization from the user.

In some implementations, a triggering event may include a date, a time, and/or an event of a calendar of the user. In some implementations, the user may identify the calendar and may submit information that causes color customizing application 220 to be synchronized with the calendar of the user.

For example, the user may identify the triggering events as including weekdays at 8 AM, 12 PM, and 8 PM; every other Tuesday at 2 PM; every 3 hours; a start and/or an end of a calendar event (such as a meeting, a birthday, etc.), or the like. Additionally, or alternatively, the user may indicate that color customizing application 220 is to cause a camera, associated with user device 210, to capture an image of a user item of the user based on detecting a triggering event. Additionally, or alternatively, the user may indicate that color customizing application 220, based on detecting a triggering event, is to obtain information regarding a color scheme of another device (e.g., of the user or of another user). Additionally, or alternatively, the user may indicate that color customizing application 220, based on detecting a calendar event as a triggering event, is to identify a color scheme that is based on the calendar event (e.g., a color scheme based on a type of the calendar event, a color scheme based on a description and/or information included in the calendar event, etc.).

In some implementations, a triggering event may include a change in a location of user device 210, a change in conditions associated with the location (e.g., a change in weather, a change in traffic, etc.), a change in altitude, a change in speed, or other changes associated with locations of the user. For example, the weather may include temperature, humidity, precipitation, etc. In some implementations, a triggering event may include a request, from the user, to identify a color scheme based on various factors and to apply the color scheme to user device 210. For example, the various factors may include information captured using a camera associated with user device 210, information captured using a microphone associated with user device 210, information captured using a Global Positioning System (GPS) associated with user device 210, textual information (e.g., text) submitted by the user, vocal information submitted by the user, etc.

Additionally, or alternatively, the configuration information may include information identifying color scheme(s). For example, the user of user device 210 may submit, via color customizing application 220, information identifying different color schemes for the user thereby creating and/or modifying the color schemes. In some implementations, the user may submit information identifying a color to replace a color of a user item of the user. For example, the user may identify sky blue as the color that would replace a user item that is green.

In some implementations, the user may submit information identifying a respective color scheme for different emotions expressed by the user. For example, the user may identify a first color scheme for the emotion of happy, a second color scheme for the emotion of sad, a third color scheme for the emotion of anger, etc. In some implementations, the user may submit information identifying a respective color scheme for different medical conditions (of the user and/or of another user). For example, the user may identify a first color scheme for the medical condition of sick, a second color scheme for the medical condition of healthy, a third color scheme for the medical condition of convalescent, etc. In some implementations, the user may submit information identifying a respective color scheme for different quantities of communications and/or calendar events associated with the user. For example, the user may identify a first color scheme for a first quantity, a second color scheme for a second quantity, a third color scheme for a range of quantities, etc. In some implementations, the user may submit information identifying a respective color scheme for different types of news and/or different news topics. For example, the user may identify a first color scheme for national news, a second color scheme for international news, a third color scheme for a particular news topic (e.g., financial news), etc. In some implementations, the user may submit information identifying a respective color scheme for different locations of the user. For example, the user may identify a first color scheme for a restaurant, a second color scheme for a movie theater, a third color scheme for a sporting arena, etc. In some instances, the user may identify a respective color scheme for different subcategories of a particular category of location. For example, the user may identify one color scheme for a seafood restaurant, may identify another color scheme for a steakhouse restaurant, etc. In some instances, the user may identify a respective color scheme for different social events at the location. For example, the user may identify one color scheme for a sporting event and/or a type of sporting event, may identify another color scheme for a concert and/or a type of concert, etc. In some implementations, the user may submit information identifying a respective color scheme based on conditions associated with the locations (e.g., weather, humidity, precipitation, etc.), based on current traffic conditions, based on a current speed of user device 210, etc. In some implementations, the user may submit information to cause color customizing application 220 to automatically apply a respective color scheme of a respective location of different entities when the user is located at the respective location. In some implementations, the user may submit information to cause color customizing application 220 to apply the respective color scheme after receiving authorization from the user.

In some implementations, the user may submit information identifying a respective color scheme for different calendar events of the user. For example, the user may identify a first color scheme for a meeting related to work, a second color scheme for a birthday event, a third color scheme for a social network event, etc. The calendar events may include historical events and/or holidays, such as Independence Day, Memorial Day, Pearl Harbor day, religious holidays, etc. In some implementations, the user may submit information identifying a respective color scheme for different types of weather (e.g., associated with a location of the user), different types of traffic (e.g., associated with a location of the user), or the like.

Additionally, or alternatively, the configuration information may include additional information for configuring color customizing application 220. For example, the user of user device 210 may submit, via color customizing application 220, additional information for configuring color customizing application 220. In some implementations, the user may submit information indicating a manner in which color customizing application 220 is to cause a color scheme to be applied to different user interfaces of user device 210 (e.g., user interfaces of different applications of user device 210). For example, the user may submit information indicating a manner in which color customizing application 220 is to cause a color associated with a lock screen user interface of user device 210 (e.g., a background color) to match a primary color of the color scheme, a color associated with a home screen user interface of user device 210 to match a secondary color of the color scheme and a texture represented by the color scheme, colors of application icons of the home screen to match the primary color, a color associated with user interfaces of one or more applications of user device 210 to match a combination of the secondary color and a tertiary color of the color scheme, a color of one or more portions of user interfaces of a particular application of user device 210 to match an object represented by the color scheme, etc. The above example is merely one example of a manner in which a color scheme may be applied to user interfaces of user device 210. A color scheme may be applied to user interfaces in many other different ways.

In some implementations, the user may submit information that causes color customizing application 220 to identify and to apply a particular color scheme to user device 210. For example, the user may submit information indicating that color customizing application 220 is to identify a particular color scheme (e.g., a color scheme being used by a threshold number of users on Mondays at 8 AM) and is to automatically apply the particular color scheme to user device 210. In some implementations, the user may submit information identifying components of user device 210 that color customizing application 220 is to use to capture information for customizing the color scheme of user device 210. For example, the user may submit information indicating that color customizing application 220 is to use a camera of user device 210 to capture information regarding user items of the user. Additionally, or alternatively, the user may submit information indicating that color customizing application 220 is to use a GPS, a camera, and/or a microphone of user device 210 to capture information regarding a location of user device 210. In some implementations, color customizing application 220 may automatically identify the components of user device 210 to use to capture the information for customizing the color scheme of user device 210.

In some implementations, the user may submit information indicating whether color customizing application 220 is to cause information regarding the user (e.g., colors of user items of the user, information regarding a location of the user, information regarding an emotion of the user, etc.) to be automatically captured based on a triggering event or whether color customizing application 220 is to provide feedback (e.g., audio and/or visual) prior to the information being captured. For example, the user may submit information indicating that color customizing application 220 is to cause an image of the user items to be automatically captured unless color customizing application 220 is unable to cause the image of the user items to be automatically captured (e.g., due to a malfunction of one or more of the above components of user device 210).

In some implementations, the user may submit information regarding the transmission of information regarding the color scheme. For example, the user may submit information indicating that the information regarding the color scheme is to be transmitted periodically to server 240 and/or to devices 260 (e.g., for the color scheme to be applied devices 260). Additionally, or alternatively, the user may submit information indicating that the information regarding the color scheme is to be transmitted to server 240 and/or devices 260 based on user input.

As further shown in FIG. 4, process 400 may include storing the configuration information and configuring the application based on the configuration information (block 450). For example, the configuration information may be stored in a data structure associated with user device 210. In some implementations, the configuration information may be transmitted to a device 260 (onto which color customizing application 220 has been downloaded) to configure color customizing application 220 of the device 260. For example, the configuration information may be used to automatically configure color customizing application 220 of the device 260. In some implementations, user device 210 may receive, from another device 260 (e.g., associated with the user), the configuration information generated by configuring color customizing application 220 on the other device 260. By way of example, the configuration information, received from the other device 260, may be combined with the configuration information of user device 210 to further configure color customizing application 220 of user device 210. In some implementations, when color customizing application 220 identifies a configuration conflict relative to the configuration information, color customizing application 220 may provide information identifying the conflict to the user and receive input from the user to resolve the conflict. In some implementations, color customizing application 220 may automatically resolve the conflict based on application usage information.

In some implementations, the configuration information may be generated for each user of different users of user device 210. For example, color customizing application 220 may enable each user to create an account that may be accessed using a username and/or a password unique to each user, log into the account using the username and/or password, and configure color customizing application 220 to generate configuration information that may be stored in one or more data structures.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

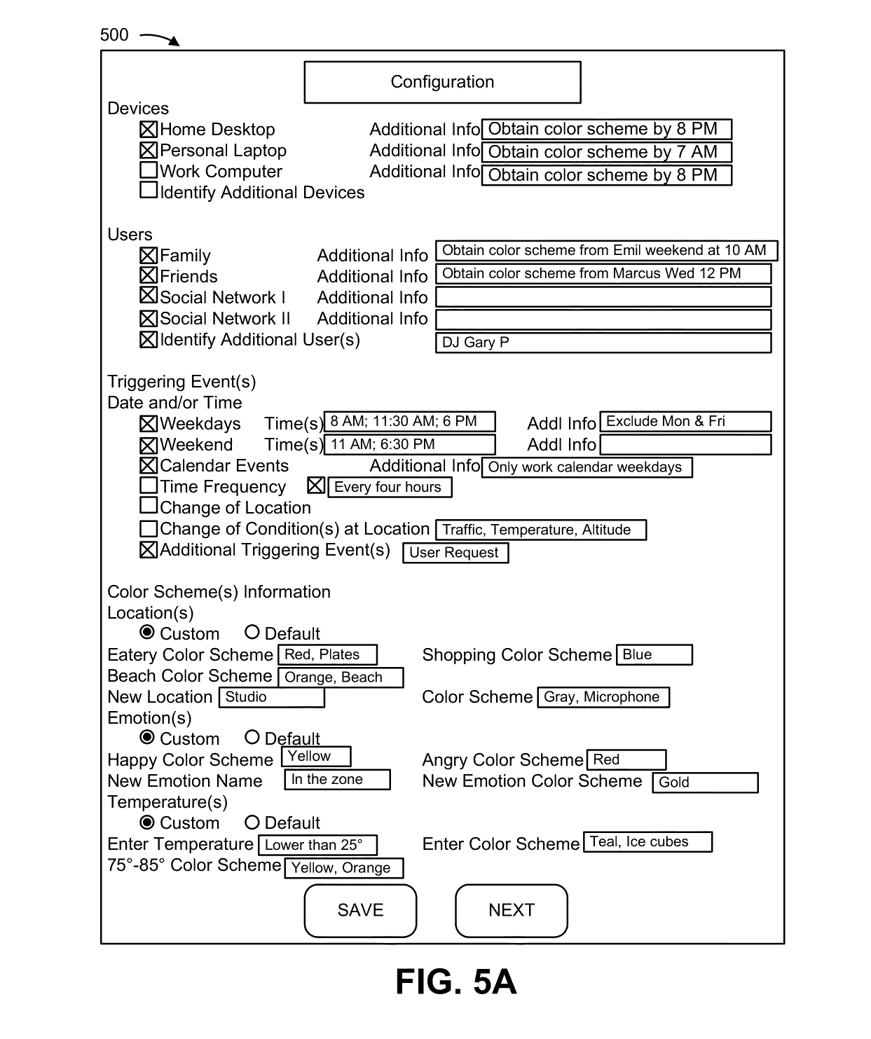

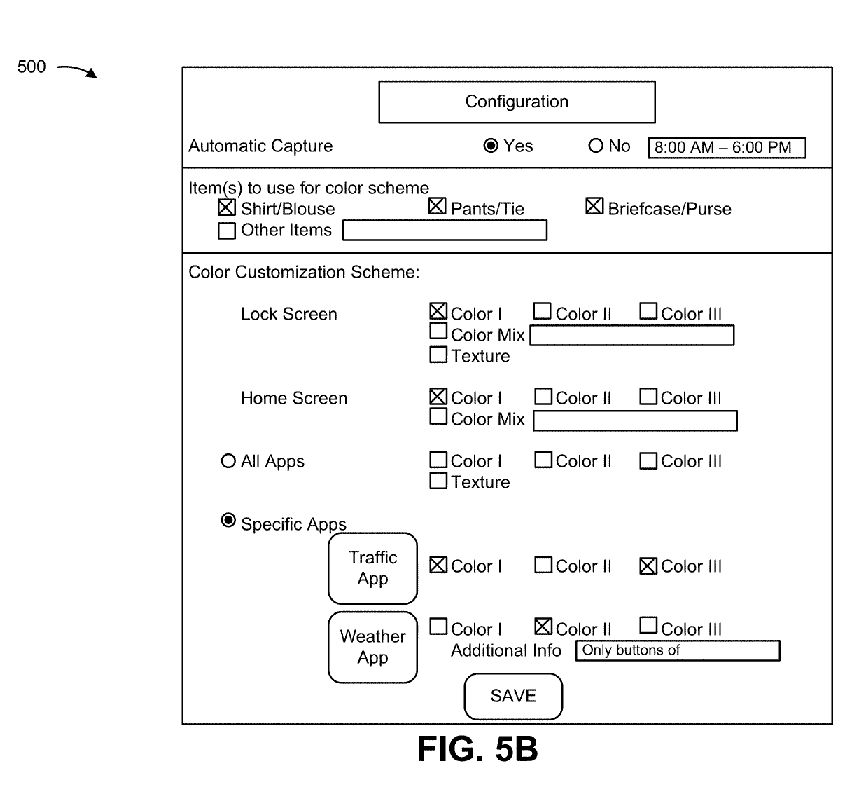

FIGS. 5A-5B are diagrams of an example 500 of process 400 described above with respect to FIG. 4. In example 500, assume that a user, associated with user device 210, has downloaded color customizing application 220 onto user device 210 and that color customizing application 220 has been installed on user device 210. Further assume that the user has initiated color customizing application 220 on user device 210. Further assume that the user desires to configure color customizing application 220.

As shown in relation to FIG. 5A, color customizing application 220 may cause user device 210 to provide a user interface that may allow the user to configure color customizing application 220. For example, as shown in relation to FIG. 5A, the user interface may allow the user to identify different devices and users that are to receive information regarding color schemes of user device 210. As such, the information regarding the color schemes may be transmitted to the different devices (including devices of the users) and the color schemes may be applied to the devices. As further shown as an example in FIG. 5A, the different devices may include a home desktop of the user, a personal laptop of the user, and a work computer of another user (e.g., a coworker of the user). As further shown as an example in FIG. 5A, the users may include family members, friends, and members of different social networks of the user. As further shown in relation to FIG. 5A, the user may identify particular dates and/or times at which user device 210 may obtain the information regarding the other color schemes from the different devices (including the devices of the users). As such, the information regarding the other color schemes may be obtained from the different devices at the particular dates and/or times and the other color schemes may be applied to user device 210.

As further shown in relation to FIG. 5A, the user interface may allow the user to identify triggering events that cause color customizing application 220 to obtain information. The obtained information may be used to identify a color scheme to be applied to user device 210. For example, as shown as an example in relation to FIG. 5A, the user may identify the triggering events as particular dates and/or times, calendar events, or a request from the user. Additionally, as further shown as an example in relation to FIG. 5A, the user may identify a particular calendar of the user. Although not shown, the user interface may also allow the user to identify the information to be obtained and/or a manner in which the information is to be obtained. For example, the user may indicate that color customizing application 220 is to cause user device 210 to obtain information regarding a color of a user item (e.g., using a camera associated with user device 210), information regarding an emotion expressed by the user (e.g., using the camera or using a microphone associated with user device 210), information regarding a location of user device 210 (e.g., using the microphone, using a GPS associated with user device 210, etc.), or the like.

As further shown in relation to FIG. 5A, the user interface may also allow the user to identify a respective color scheme for different types of information (e.g., information regarding locations of the user, information regarding emotions of the user, etc.). For example, as further shown as an example in FIG. 5A, the user may identify a respective color scheme for different types of locations, for different types of emotions, and/or for different temperatures at a location of the user. Alternatively, or additionally, the user may use the default color schemes for the different types of information.

As further shown in relation to FIG. 5A, the user interface may allow the user to select a “SAVE” option to save the information submitted by the user as configuration information or to select a “NEXT” option to identify additional information to configure color customizing application 220.

As shown in relation to FIG. 5B, color customizing application 220 may cause user device 210 to provide a user interface that may allow the user to further configure color customizing application 220. For example, as shown in relation to FIG. 5B, the user interface may also allow the user to identify an “Automatic Capture” option that may cause color customizing application 220 to automatically obtain the information used to identify a color scheme for user device 210. In conjunction with the “Automatic Capture” option, the user may identify particular dates and/or times at which the information may be obtained. As further shown in relation to FIG. 5B, the user interface may also allow the user to identify user items that may be used to identify a color scheme for user device 210. As shown as an example in relation to FIG. 5B, the user items may include Shirt/Blouse, Pants/Tie, and Briefcase/Purse.

As shown in relation to FIG. 5B, the user may identify a manner in which a respective portion of a color scheme may be applied to different user interfaces of user device 210. As further shown as an example in relation to FIG. 5B, the user may indicate that a primary color of the color scheme and a texture represented by the color scheme are to be applied to a lock screen user interface of user device 210 and may indicate that the primary color is to be applied to a home screen user interface of user device 210. As further shown as an example in FIG. 5B, the user may indicate that a primary color and a secondary color of the color scheme are to be applied to user interfaces of a traffic application of user device 210 and may indicate that the secondary color is to be applied to user interfaces of a weather application of user device 210. As further shown in relation to FIG. 5B, the user interface may allow the user to select a “SAVE” option to save the information submitted by the user as the configuration information.

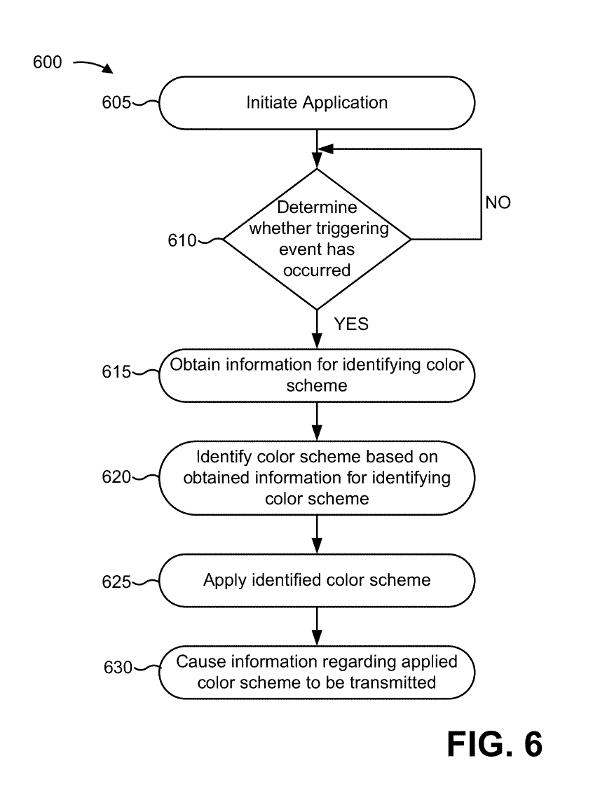

FIG. 6 is a flowchart of an example process for customizing color schemes of the user device. In some implementations, process 600 may be performed by user device 210. In some implementations, one or more process blocks of FIG. 6 may be performed by another device or a group of devices separate from or including user device 210, such as another device included in environment 200.

As shown in FIG. 6, process 600 may include initiating the application (block 605). For example, user device 210 may receive a request (e.g., from a user of user device 210) to initiate color customizing application 220 and may cause color customizing application 220 to be initiated based on the request. In some implementations, upon initiation, color customizing application 220 may provide, for display, information regarding particular color schemes (as explained above with respect to block 430 of process 400). For example, the particular color schemes may include a color scheme that has been previously used by the user, a color scheme that meets a threshold of usage by the user, a color scheme that is preferred by the user, etc. In some implementations, color customizing application 220 may identify and provide, for display, a particular color scheme based on the configuration information. For example, based on the configuration information, every weekday at 8:00 AM, color customizing application 220 may transmit a request (e.g., to server 240, to devices 260, to other devices, etc.) for a color scheme being used at 8:00 AM. by a threshold quantity of users (e.g., by most users).

In some implementations, upon initiation, color customizing application 220 may provide, for display, statistical information regarding the user. The statistical information may include information regarding colors (of user items) that are worn by the user (e.g., most worn and/or least worn by the user out of colors of user items worn by the user). Additionally, or alternatively, the statistical information may include information regarding color schemes (of user items) worn by the user (e.g., most worn and/or least worn by the user). Additionally, or alternatively, the statistical information may include information regarding portions of the user's skin covered with clothing and/or not covered with clothing (e.g., percentage of skin exposed versus percentage of skin covered with clothing). The information regarding the colors, the color schemes, and the user's skin may be provided with respect to different locations of the user (e.g., work, school, restaurant, etc.), different activities relating to the user (e.g., attending a social event, exercising, vacationing, etc.), different times of day (e.g., morning, day, night, weekday, weekend, etc.), etc. In some implementations, the statistical information may be provided based on a request from the user or may be provided automatically. In some implementations, the statistical information may be generated by user device 210 via color customizing application 220. Additionally, or alternatively, the statistical information may be generated by server 240 and transmitted to user device 210. The statistical information may be generated based on information regarding color schemes used, information used to identify the color schemes, etc.

As further shown in FIG. 6, process 600 may include determining whether a triggering event has occurred (block 610). For example, after initiating color customizing application 220, user device 210, via color customizing application 220, may determine whether a triggering event (that causes color customizing application 220 to obtain information for identifying a color scheme) has occurred. In some instances, user device 210 may make the determination based on the triggering events identified in the configuration information.

In some implementations, color customizing application 220 may detect that a current date and/or a current time matches a particular date and/or a particular time (e.g., identified in the configuration information). For example, the user may have identified the particular date and/or the particular time as a triggering event during the configuration of color customizing application 220. In some implementations, color customizing application 220 may detect an occurrence of a time interval that corresponds to a particular time interval (e.g., identified in the configuration information). For example, the user may have identified the time interval during the configuration. In some implementations, color customizing application 220 may detect a calendar event as a triggering event. For example, color customizing application 220 may detect a start of the calendar event and/or an end of the calendar event as the triggering event.

In some implementations, color customizing application 220 may detect a user request to identify a color scheme to be applied to user device 210 as the triggering event. For example, the user may use a camera associated with user device 210 to capture an image (e.g., of a user item of the user, of a face of the user, of a location of the user, etc.) and may submit, via color customizing application 220, a request to apply a color scheme that is based on the captured image to user device 210. Additionally, or alternatively, the user may use a microphone associated with user device 210 to obtain information (e.g., regarding the user item, an emotion of the user, the location, a quantity of communications and/or calendar events associated with the user, a medical condition (of the user and/or of another user), an event associated with the user, news, etc.) and may submit, via color customizing application 220, a request to apply the color scheme to user device 210. Additionally, or alternatively, the user may submit textual information (e.g., information regarding the color of the user item, the emotion, the location, the medical condition, the quantity of communications and/or calendar events, the event, the news, etc.), via color customizing application 220, and may submit, via color customizing application 220, a request to apply the color scheme to user device 210. Additionally, or alternatively, the user may cause user device 210 to capture the location using a GPS associated with user device 210 and submit a request, via color customizing application 220, to apply the color scheme to user device 210.

In some implementations, color customizing application 220 may detect a change in a location of user device 210 or a change in condition associated with the location as the triggering event. For example, color customizing application 220 may detect a change in weather, in traffic, etc. In some implementations, color customizing application 220 may detect a change in altitude or a change in speed as the triggering event. In some implementations, color customizing application 220 may detect the changes based on obtaining information regarding the changes. For example, color customizing application 220 may obtain the information regarding the changes from a web site that tracks changes in weather. Additionally, or alternatively, color customizing application 220 may obtain the information regarding the changes from a thermometer, a speedometer, an altimeter, a microphone, and/or a camera. The thermometer, the speedometer, the altimeter, the microphone, and the camera may be included in user device 210 and/or one or more devices 260.

As further shown in FIG. 6, if no triggering event has occurred (block 610—NO), then process 600 may return to block 610. As further shown in FIG. 6, if a triggering event has occurred (block 610—YES), then process 600 may include obtaining information for identifying a color scheme to be applied to user device 210 (block 615). For example, color customizing application 220 may cause user device 210 to obtain the information (e.g., news, information regarding a user item of the user, information regarding a medical condition of the user and/or of another user, information regarding an emotion expressed by the user, information regarding a quantity of communications and/or calendar events associated with the user, information regarding an event associated with the user, and/or information regarding a location of the user) when the triggering event has occurred.

In some implementations, color customizing application 220 may cause user device 210 to obtain the information automatically based on the configuration information indicating that the information is to be obtained automatically. Additionally, or alternatively, based on the configuration information, color customizing application 220 may cause user device 210 to obtain the information based on input from the user. For example, color customizing application 220 may receive a request from the user to obtain the information. Additionally, or alternatively, color customizing application 220 may request authorization from the user prior to obtaining the information. For instance, color customizing application 220 may cause user device 210 to output audible information, visual information, textual information, or the like to request the authorization. In some implementations, color customizing application 220 may provide instructions (e.g., via audible information, visual information, textual information, or the like) to guide the user in using user device 210 to obtain the information.

In some implementations, color customizing application 220 may obtain the information using a camera associated with user device 210, a microphone associated with user device 210 (e.g., vocal information from the user, sounds at a location of the user, etc.), a GPS associated with user device 210, or the like. For example, the camera, the microphone, and/or the GPS may be included in user device 210 and/or may be peripherals of user device 210. Additionally, or alternatively, color customizing application 220 may obtain the information as textual information submitted by the user. In some implementations, color customizing application 220 may obtain the information from content (e.g., image files, video files, sound files, text files, calendar entries, or the like) stored on user device 210 or stored on other devices (e.g., devices 260, server 240, etc.). For example, color customizing application 220 may analyze the content to identify information regarding a color (e.g., of a user item), an emotion, a location, a medical condition, a condition associated with the location, an event associated with the user, a quantity of communications and/or calendar events associated with the user, etc.

In some implementations, the information for identifying the color scheme may include information regarding a user item of the user. For example, color customizing application 220 may cause user device 210 to obtain information regarding a color of the user item. As explained above, the color of the user item may include a color of the user item, a texture of the user item (e.g., patent leather, fur, leather, silk, satin, rubber, or the like), a pattern of the user item (e.g., leopard prints, polka dots, paisley, or the like). In some implementations, the user may cause the camera associated with user device 210 to capture an image of the user item. Color scheme customization application 220 may analyze the image to identify the color of the user item. Additionally, or alternatively, the user may type or utter the information regarding the color of the user item.

Additionally, or alternatively, the information for identifying the color scheme may include information regarding a location of the user. For example, color customizing application 220 may cause user device 210 to obtain information regarding the location. In some implementations, color customizing application 220 may cause the GPS associated with user device 210 to obtain the information regarding the location. Additionally, or alternatively, the user may type or utter the information regarding the location. Additionally, or alternatively, color customizing application 220 may cause the camera associated with user device 210 to capture (automatically or based on input from the user) an image of the location. For example, the user may use the camera to capture an image of the name of the location (e.g., “Emil's British Fine Dining Restaurant” or “DJ Gary P—Old Skool Nite”). Color scheme customization application 220 may analyze the image to identify the location. Additionally, or alternatively, color customizing application 220 may cause the microphone associated with user device 210 to capture (automatically or based on input from the user) sounds at the location and may analyze the sounds to identify the location. In some implementations, the information regarding the location may include a name of the location, geographical coordinates of the location, conditions associated with the location (e.g., weather, traffic, altitude, etc.), information regarding speed, or the like.

Additionally, or alternatively, the information for identifying the color scheme may include information regarding an emotion expressed by the user. For example, color customizing application 220 may obtain the information regarding the emotion expressed by the user. In some implementations, color customizing application 220 may cause the camera associated with user device 210 to capture (automatically or based on input from the user) an image of a face of the user and may analyze the image to identify the emotion. Additionally, or alternatively, color customizing application 220 may cause the microphone associated with user device 210 to capture (automatically or based on input from the user) a voice of the user and may analyze the voice to identify the emotion. For example, color customizing application 220 may analyze a frequency of the voice, a pattern of the voice, or the like to identify the emotion. Additionally, or alternatively, color customizing application 220 may cause the microphone to capture the user uttering a phrase identifying the emotion, such as the phrase “I am happy!” or the phrase “I am in the zone!”

Additionally, or alternatively, the information for identifying the color scheme may include information regarding a medical condition (of the user and/or of another user). For example, color customizing application 220 may obtain the information regarding the medical condition to capture (automatically or based on input from the user) an image of a face of the user and may analyze the image to identify the medical condition. Additionally, or alternatively, color customizing application 220 may cause the microphone associated with user device 210 to capture (automatically or based on input from the user) a voice of the user and may analyze the voice to identify the medical condition. Additionally, or alternatively, color customizing application 220 may cause the microphone to capture the user uttering a phrase identifying the medical condition, such as the phrase “I am sick today” or the phrase “My brother Gary is not feeling well today.” Additionally, or alternatively, color customizing application 220 may receive textual information, submitted by the user, that identifies the medical condition.

Additionally, or alternatively, the information for identifying the color scheme may include information regarding the quantity of communications and/or calendar events associated with the user. For example, color customizing application 220 may receive vocal and/or textual information, submitted by the user, that identify the quantity of communications and/or calendar events associated with the user.

Additionally, or alternatively, the information for identifying the color scheme may include information regarding the news. For example, color customizing application 220 may obtain the information regarding the news from data feeds, such as web site feeds. Additionally, or alternatively, the information for identifying the color scheme may include information regarding the event associated with the user. For example, color customizing application 220 may obtain the information regarding the event from the content stored on user device 210 or stored on the other devices.

As further shown in FIG. 6, process 600 may include identifying the color scheme based on the obtained information (block 620). For example, color customizing application 220 may cause a search to be performed to identify the color scheme that corresponds to the obtained information (for identifying the color scheme). In some implementations, color customizing application 220 may search different color schemes, using the obtained information, to identify the color scheme that corresponds to the obtained information. The different color schemes may include the color schemes received with color customizing application 220 and/or the color schemes identified in the configuration information. For example, color customizing application 220 may compare a portion or an entirety of the obtained information to information regarding the different color schemes to identify a match. For instance, color customizing application 220 may identify a color scheme of a respective location of different entities when color customizing application 220 determines that a location of the user (identified in the obtained information) corresponds to the respective location. The level of match may be configured by the user. Additionally, or alternatively, color customizing application 220 may transmit a request for the color scheme that corresponds to the obtained information and may receive information regarding the color scheme based on transmitting the request. The request may include the obtained information. Additionally, the request may include information regarding the level of match. For example, the request may be transmitted to server 240, to devices 260, and/or to other devices. For instance, color customizing application 220 may cause a search of color schemes to be performed, using the obtained information and/or the information regarding the level of match, on the Internet to identify the color scheme that corresponds to the obtained information.

As further shown in FIG. 6, process 600 may include applying the color scheme (block 625). For example, color customizing application 220 may cause the color scheme to be applied to user device 210. For instance, the color scheme may be applied based on information, in the configuration information, indicating a manner in which colors schemes are to be applied and/or based on default settings of color customizing application 220 indicating a manner in which colors schemes are to be applied. In some implementations, color customizing application 220 may cause user device 210 to display information identifying the color scheme to the user and color customizing application 220 may apply the color scheme after the user selects the information identifying the color scheme. For example, color customizing application 220 may automatically apply a respective color scheme of a respective location of different entities when color customizing application 220 determines that a location of the user corresponds to the respective location. Additionally, or alternatively, color customizing application 220 may provide information regarding the respective color scheme to the user and may apply the respective color scheme after detecting a selection of the information regarding the respective color scheme. In some implementations, color customizing application 220 may automatically apply the color scheme. In some implementations, color customizing application 220 may cause the color scheme to be applied to different user interfaces of user device 210, such as a home screen user interface, a lock screen user interface, a desktop user interface, user interfaces of different applications of user device 210, or the like (as explained above with respect to additional information for configuring color customizing application 220). For example, color customizing application 220 may cause user device 210 to display, to the user, information identifying color schemes (e.g., identified based on colors, detected by color customizing application 220, in an image captured by the camera associated with user device 210). The information identifying the color schemes may be displayed as suggestions for a frame for the image. Color customizing application 220 may then create the frame for the image based on information identifying one of the color schemes selected by the user. Additionally, or alternatively, the color scheme may correspond to an eye color of the user and color customizing application 220 may apply the color scheme to a self-portrait image of the user captured by the camera.

Additionally, or alternatively, color customizing application 220 may apply the color scheme by creating a wallpaper based on the color scheme. In some implementations, when multiple color schemes are identified based on the obtained information, color customizing application 220 may cause (automatically or based on input from the user) each of the multiple color schemes to be applied to different user interfaces of user device 210. For example, color customizing application 220 may cause a first color scheme to be applied to a first user interface, a second color scheme to be applied to a second user interface, etc.

As further shown in FIG. 6, process 600 may include causing information regarding the color scheme to be transmitted (block 630). For example, color customizing application 220 may cause user device 210 to transmit the information regarding the color scheme to other devices, such as server 240 and/or devices 260 (e.g., devices of co-workers of the user, family members of the users, friends of the user, members of a social network of the user, etc.), and may cause the color scheme to be applied to devices 260. Additionally, alternatively, color customizing application 220 may cause server 240 and/or devices 260 to store the information regarding the color scheme. The information regarding the color scheme may be transmitted via a network, such as network 230. In some implementations, color customizing application 220 may cause user device 210 to transmit the information regarding the color scheme to server 240 and/or devices 260 based on input from the user and/or periodically (without user input). For example, color customizing application 220 may identify, in the configuration information, information regarding the transmission of the information regarding the color scheme and may cause user device 210 to transmit the information regarding the color scheme accordingly. As such, color customizing application 220 may enable the user, of user device 210, to control the color scheme of a group of users associated with devices 260 by selecting the color theme as a color scheme for a particular period of time (e.g., a particular hour, a particular day, a particular week, a particular month, etc.). Additionally, or alternatively, color customizing application 220 may transmit the information regarding the color scheme to devices hosting a social networking site web site and a personal web site of the user and may cause the devices to apply the color scheme to the web sites.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

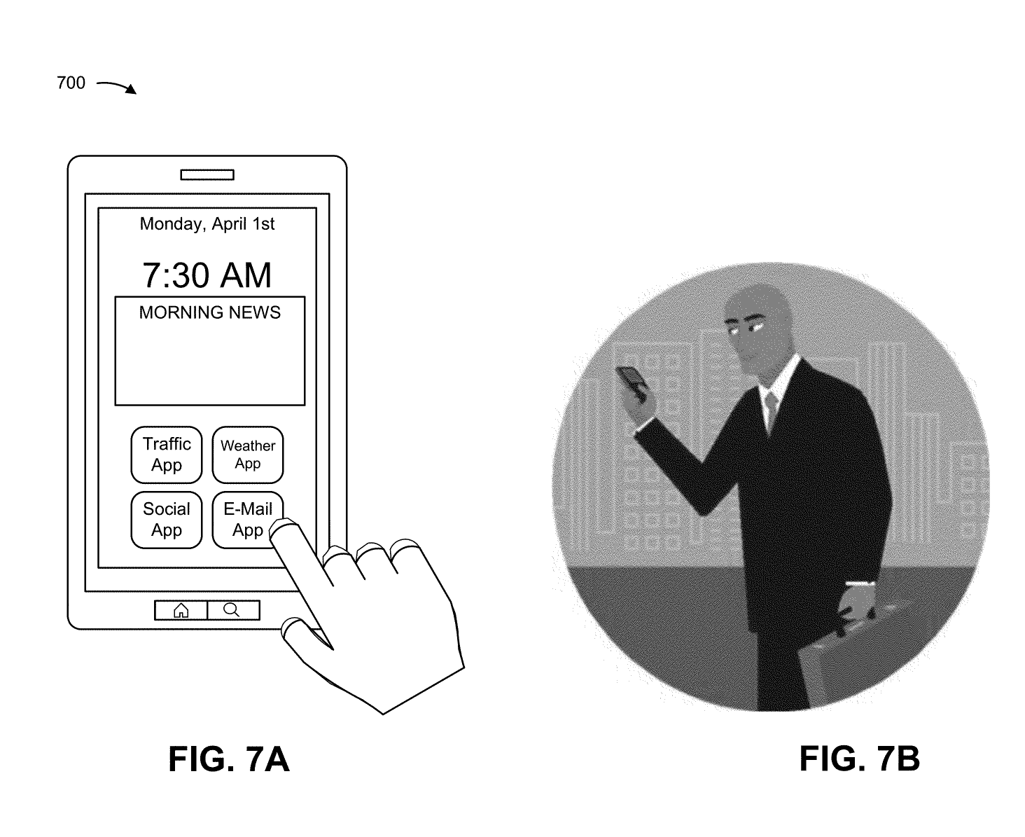

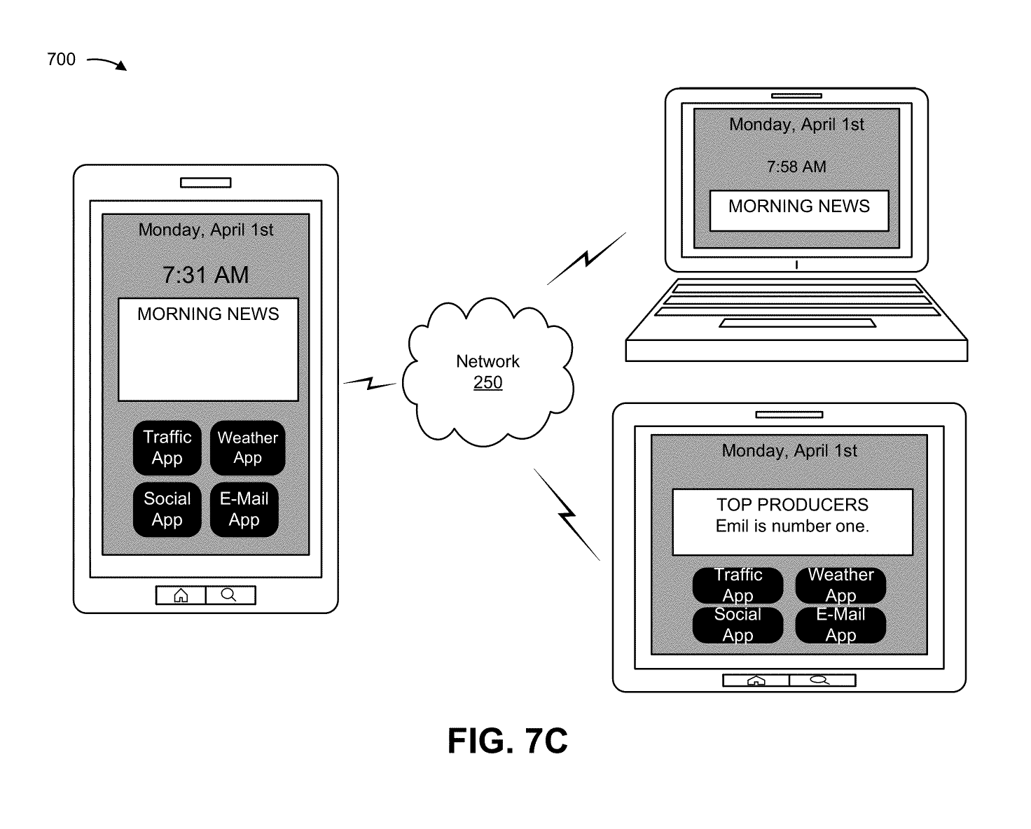

FIGS. 7A-7C are diagrams of an example 700 of process 600 described above with respect to FIG. 6. For the purposes of example 700, assume that a user is using a news application of user device 210 while the user is in transit to work. Further, assume that color customizing application 220 has been initiated and is running as a background process on user device 210. As shown in FIG. 7A, assume that color customizing application 220 has caused a camera of user device 210 to capture an image of user items of the user, such as a shirt of the user, a tie of the user, and a suit of the user. Color customizing application 220 may analyze the image to identify a color of the tie and a color of the suit.

For the purposes of example 700, further assume that color customizing application 220 has identified a color scheme corresponding to the color of the tie and the color of the suit. For example, assume color customizing application 220 has caused a search to be performed (e.g., a search of the configuration information) based on the color of the tie and the color of the suit to identify the color scheme. As shown as an example in FIG. 7C, color customizing application 220 may cause the identified color scheme to be applied to user device 210. For example, color customizing application 220 may cause a color associated with a background of the current user interface of user device 210 to match the color of the tie of the user and may cause a color associated with the application icons on the current user interface to match the color of the suit. Further assume that color customizing application 220 has caused user device 210 to transmit information regarding the identified color scheme to other devices, such as a work laptop of the user and a tablet computer of another user who is a member of a social network of the user. As further shown as an example in FIG. 7C, the identified color scheme may be applied to the work laptop and to the tablet computer, in a manner similar to user device 210, based on the information regarding the color scheme being transmitted to the work laptop and the tablet computer. Accordingly, the work laptop may reflect the identified color scheme when the user arrives at work.

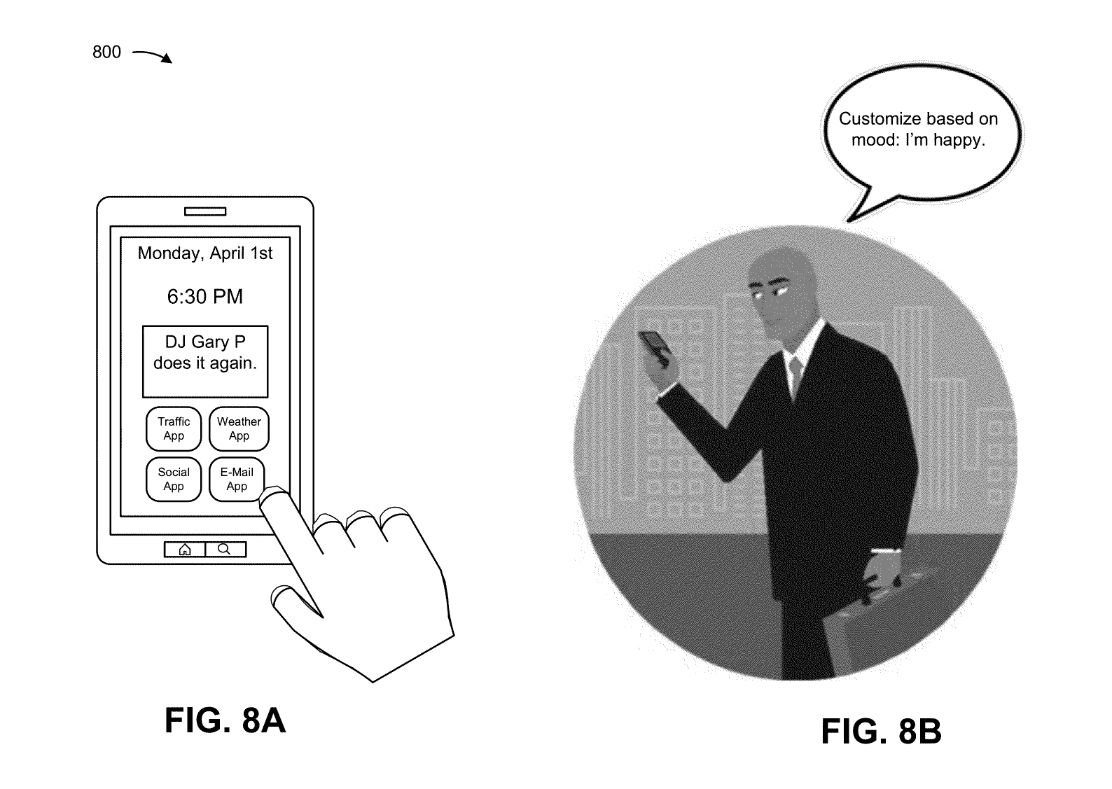

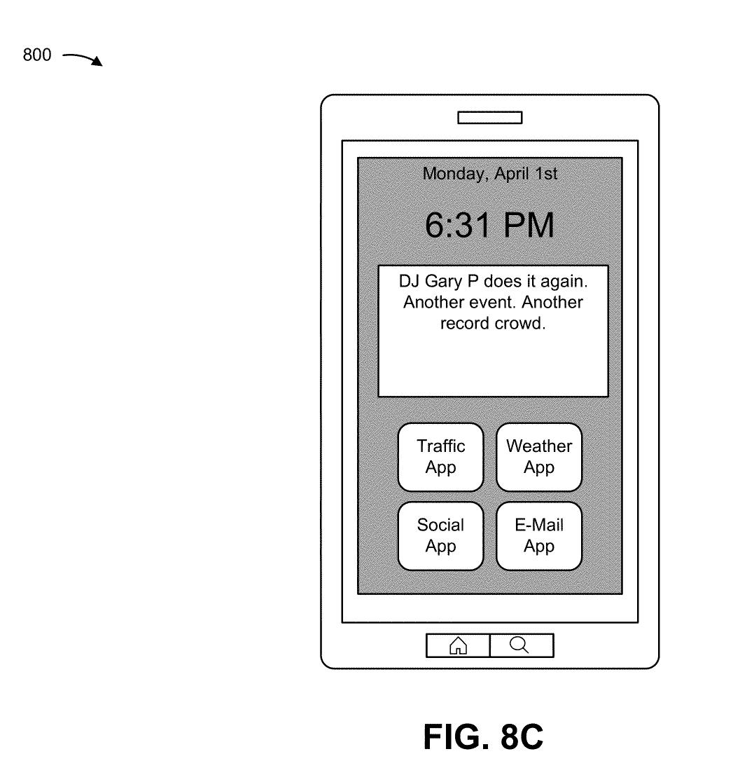

FIGS. 8A-8C are diagrams of an example 800 of process 600 described above with respect to FIG. 6. For the purposes of example 800, assume that a user is using a social media application of user device 210. Further, assume that color customizing application 220 has been initiated and is running as a background process on user device 210. As shown in FIG. 8A, assume that the user is reading a social media post regarding the user's favorite disc jockey (DJ Gary P). As shown in FIG. 8B, assume that the social media post has caused the user to be happy. As further shown in FIG. 8B, the user may vocally submit a request, to color customizing application 220, for the customization of user device 210 based on the happiness of the user.

For the purposes of example 800, further assume that color customizing application 220 has identified a color scheme corresponding to the emotion of happy based on the user's request. For example, assume color customizing application 220 has caused a search to be performed based on the emotion of happy to identify a color scheme that corresponds to the emotion of happy. As shown in FIG. 8C, color customizing application 220 may cause the identified color scheme to be applied to user device 210. As shown as an example in FIG. 8C, color customizing application 220 may cause a first color of the identified color scheme to be applied to a color of a background of the current user interface of user device 210 and may cause a second color of the identified color scheme to be applied to colors of the application icons on the current user interface.

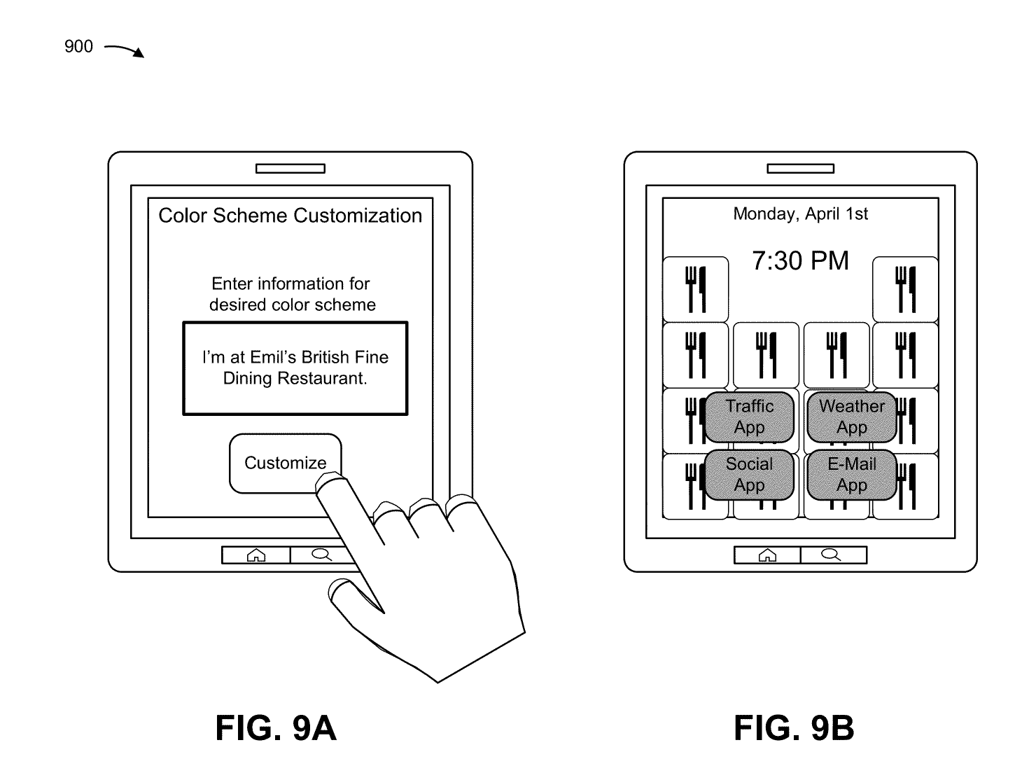

FIGS. 9A and 9B are diagrams of an example 900 of process 600 described above with respect to FIG. 6. For the purposes of example 900, assume that a user is using color customizing application 220. As shown in FIG. 9A, color customizing application 220 may provide a user interface that may enable a user to enter information regarding a desired color scheme. As further shown in FIG. 9A, the user may submit, via the user interface, information indicating that the user is at Emil's British Fine Dining Restaurant. For the purposes of example 900, further assume that color customizing application 220 has identified a color scheme corresponding to Emil's British Fine Dining Restaurant. For example, color customizing application 220 may cause a search to be performed based on the terms “Emil's British Fine Dining,” “British Fine Dining,” “British Restaurant,” and/or “Restaurant” to identify the color scheme. As shown as an example in FIG. 9B, color customizing application 220 may cause the identified color scheme to be applied to user device 210. For example, color customizing application 220 may cause a home screen user interface of user device 210 to include icons of the color scheme (e.g., icons that identify a restaurant) and may cause colors of application icons, on the home screen user interface, to match a color of the color scheme.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term component is intended to be broadly construed as hardware, firmware, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that example aspects, as described above, may be implemented in many different forms of firmware, hardware, and a combination of hardware and software in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device comprising:
a memory to store instructions;
one or more processors to execute the instructions to:
determine that a triggering event has occurred,
obtain, based on determining that the triggering event has occurred, particular information relating to identifying one or more color schemes,
the particular information relating to a color of a user item of a user, identify a particular color scheme based on the particular information, and apply the particular color scheme to a user interface of the device,
when applying the particular color scheme to the user interface, the one or more processors are to:
cause a color, associated with the user interface of the device, to match a particular color associated with the color scheme,
the particular color, associated with the color scheme,
corresponding to the color of the user item.

2. The device of claim 1, where the one or more processors are further to:
transmit information regarding the color scheme to another device to permit the color scheme to be applied to the other device.

3. The device of claim 1, where, when determining that the triggering event has occurred, the one or more processors are to:
detect at least one of a particular date or a particular time, and
determine that the trigger event has occurred based on detecting the at least one of the particular date or the particular time.

4. The device of claim 1, where, when determining that the triggering event has occurred, the one or more processors are to:
detect at least one of a start of a calendar event or an end of the calendar event, and
determine that the trigger event has occurred based on detecting the at least one of the start of the calendar event or the end of the calendar event.

5. The device of claim 1, where the one or more processors are further to:
identify:
a first color scheme that has been used by the user, or
a second color scheme that has been used by another user,
provide, for display, information identifying the first color scheme or information identifying the second color scheme,
detect selection of the information identifying the first color scheme or the information identifying the second color scheme, and
apply the first color scheme or the second scheme to the device based on detecting the selection.

6. The device of claim 1, where, when obtaining the particular information relating to identifying the one or more color schemes, the one or more processors are to at least one of:
obtain, as the particular information, an image of the user item using a camera of the device,
receive vocal information, from the user, as the particular information,
the vocal information identifying the user item, or
receive textual information, from the user, as the particular information,
the textual information identifying the user item.

7. The device of claim 1, where the one or more processors are further to:
obtain information regarding an emotion expressed by the user,
identify another color scheme based on the information regarding the emotion expressed by the user, and
apply the other color scheme to a particular user interface of the device.

8. The device of claim 1, where the one or more processors are further to:
obtain information regarding a location of the user,
identify another color scheme based on the information regarding the location, and
apply the other color scheme to a particular user interface of the device.

9. A method comprising:
determining, by one or more processors of a device of a user, that an event has occurred;
obtaining, by the one or more processors and based on determining that the event has occurred, particular information,
the particular information relating to:
information regarding a user item of a user, or
information regarding an emotion expressed by the user,
identifying, by the one or more processors, a particular color scheme based on the particular information; and
applying, by the one or more processors, the particular color scheme to a plurality of user interfaces of the device,
applying the particular color scheme to the plurality of user interfaces including:
causing a color, associated with a first one of the plurality of user interfaces, to match a first color associated with the color scheme, and
causing a color, associated with a second one of the plurality of user interfaces, to match a second color associated with the color scheme.

10. The method of claim 9, further comprising:
providing information identifying the color scheme for display; and
receiving selection, from the user, of the information identifying the color scheme,
where applying the particular color scheme includes applying the particular color scheme based on receiving the selection from the user.

11. The method of claim 9, where applying the particular color scheme to the plurality of user interfaces includes:
applying the particular color scheme to the plurality of user interfaces without input, from the user, to apply the particular color scheme to the plurality of user interfaces.

12. The method of claim 9, further comprising:
providing, for display, information identifying color schemes that meet a threshold of usage by a plurality of users;
detecting selection of information identifying one of the color schemes; and
applying the one of the color schemes to at least one of the plurality of user interfaces of the device.

13. The method of claim 9, further comprising:
obtaining information regarding a temperature associated with a location of the user;
identifying another color scheme based on the information regarding the temperature; and
apply the other color scheme to at least one of the plurality of user interfaces of the device.

14. The method of claim 9, further comprising:
determining that a location of the user corresponds to a location of a particular entity;
identifying a color scheme of the location of the particular entity based on determining that the location of the user corresponds to the location of the particular entity; and
applying the color scheme to at least one of the plurality of user interfaces.

15. The method of claim 9, further comprising:
identifying a plurality of color schemes,
the plurality of color schemes including the particular color scheme,
where applying the particular color scheme to the plurality of user interfaces includes:
causing a color, associated with a third one of the plurality of user interfaces, to match a color associated with another particular color scheme of the plurality of schemes.

16. A computer-readable medium storing instructions, the instructions comprising:
one or more instructions which, when executed by one or more processors of a device of a user, cause the one or more processors to obtain particular information,
the particular information relating to:
information regarding a user item of the user, or
information regarding a location of the user;
one or more instructions which, when executed by the one or more processors, cause the one or more processors to identify a particular color scheme based on the particular information; and
one or more instructions which, when executed by the one or more processors, cause the one or more processors to apply the particular color scheme to one or more user interfaces of the device,
the one or more instructions to apply the particular color scheme to the one or more user interfaces including:
one or more instructions to cause a color, associated with the one or more user interfaces, to match a color of the particular color scheme.

17. The computer-readable medium of claim 16, where the instructions further comprise:
one or more instructions to transmit information regarding the particular color scheme to another device to cause permit the particular color scheme to be applied to the other device.

18. The computer-readable medium of claim 16, where the one or more instructions to obtain the particular information include:
one or more instructions to obtain, as the particular information, an image of the user item or an image of the location using a camera of the device;
one or more instructions to receive vocal information, from the user, as the particular information; or
one or more instructions to receive textual information, from the user, as the particular information.

19. The computer-readable medium of claim 18, where the instructions further comprise:
one or more instructions which, when executed by the one or more processors, cause the one or more processors to detect an event that includes:
a change in a condition associated with the location,
at least one of a particular date or a particular time, or
at least one of a start of a calendar event or an end of the calendar event, where the particular information is obtained based on detecting the event.

20. The computer-readable medium of claim 16, where the one or more instructions apply the particular color scheme to the one or more user interfaces include:
one or more instructions to apply the particular color scheme to the one or more user interfaces without user intervention.
